(19) United States
(12) Patent Application Publication
(10) Pub. No.: US 2003/0048510 A1
(43) Pub. Date: Mar. 13, 2003

(54) Remote control transmitter and method of inspecting the transmitter

(76) Inventors: Shosei Kawashima, Fukui (JP); Yoichi Hatano, Fukui (JP)

Correspondence Address: Lawrence E. Ashery, Ratner & Prestia, PO Box 980, Suite 301 One Westlake Berwyn, Valley Forge, PA, 19482-0980, US

(21) Appl. No.: 09/937,255

(22) PCT Filed: Jan. 23, 2001
(86) PCT No.: PCT/JP01/00421

(30) Foreign Application Priority Data
Jan. 24, 2000 (JP) 2000-014505

(51) Int. Cl. H04B 10/08; H04B 10/00

(52) U.S. Cl. 359/142; 359/110

(57) ABSTRACT

A remote-control transmitter for use with an electronic apparatus and a method of testing it are provided, which can be minimized in the cost of production and the overall duration of test. The transmitter has a microcomputer 11 to be shifted to a test mode when specific keys are pressed down and to store the opening-closing data of the keys closed after the test mode is initiated. The opening-closing data of the keys are then transferred as a remote-control test signal to a transmission circuit at once.

### TECHNICAL FIELD

The present invention relates to a remote-control transmitter for use with an electronic apparatus such as a television receiver or a video recorder/player and a method of testing the transmitter.

### BACKGROUND ART

As various types and shapes of many remote-control transmitters for remote-controlling electronic apparatuses have been proposed.

One of such conventional remote-control transmitters will now be explained referring to FIGS. 6 and 7.

FIG. 6 is a circuitry diagram of the conventional remote-control transmitter, and FIG. 7 is an external perspective view of the transmitter. A power-on key 2 and an array of channel keys 3A through 3L project from the upper surface of a box-like insulating resin case 1 with vertically moving ability. Switch contacts corresponding the keys are disposed beneath the keys and over a printed circuit board (not shown) installed in the case 1. The power-on key 2 and the channel keys 3A through 3L are coupled to a microcomputer 4 which comprises:

a) a key opening-closing detector 6 for detecting the opening and closing of each of the key switch contracts;

b) a transmission code memory 7 for storing the transmission codes of the keys; and

c) a control signal generator 8 operable to read the transmission code of the key from the opening-closing signal of each of the key from the detector 6, to generate a remote-control signal from each key, and to drive a transmission circuit 5.

In action, when the power-on key 2 is pressed, a switch contact corresponding to it closes to transmit the opening-closing signal of the power-on key 2 from the key opening-closing detector 6 to the control signal generator 8 in the microcomputer 4. Responding to the opening-closing signal, the control signal generator 8 then reads the transmission code of the power-on key 2 from the transmission code memory 7 and generates the remote-control signal of the power-on key 2 for driving the transmission circuit 5.

The transmission circuit 5 transmits the remote-control signal of the power-on key 2 as an infrared ray signal to an electronic apparatus (not shown) such as a television receiver or a video recorder/player. When receiving the infrared ray signal, the electronic apparatus turns its power supply on for enabling to be remote-controlled with the remote-control transmitter 10.

When the conventional remote-control transmitter 10 is tested, its keys are pressed one by one to transmit the corresponding infrared ray signals to a tester (not shown). The tester receives and examines the infrared ray signal whether or not its corresponding key switch contact is correctly closed.

Assuming that the pressing down of each key takes 0.1 second, the transmission of each key signal from the remote-control transmitter 10 to the tester takes 0.2 second, and the receiving and examining of the key signal in the tester takes 0.02 second, the overall duration of testing the remote-control transmitter with thirteen keys shown in FIG. 7 is:

(0.1+0.2+0.02)×13(keys)=4.16(seconds)

If the number of key is 40, the test duration is as long as 12.8 seconds.

Because the conventional remote-control transmitter requires such a long duration for testing, it is hardly reduced in its price.

### DISCLOSURE OF THE INVENTION

It is an object of the present invention to provide a remote-control transmitter and a method of testing the transmitter minimized in its price and the duration of test. The remote-control transmitter has a microcomputer capable of being shifted to a test mode when a specific key is pressed down and storing the opening-closing data of the key closed after the test mode is initiated. The opening-closing data of the key is then transferred as a remote-control test signal to a transmission circuit. As a result, the remote-control transmitter can be minimized in both its price and the duration of the testing.

### BRIEF DESCRIPTION OF THE DRAWINGS

FIG. 1 is a circuitry diagram of a remote-control transmitter according to Embodiment 1 of the present invention;

FIG. 2 is an external perspective view of the remote-control transmitter according to Embodiment 1;

FIG. 3 is a memory bit diagram of the remote-control transmitter according to Embodiment 1;

FIG. 4 is a circuitry diagram of a remote-control transmitter according to Embodiment 2 of the present invention;

FIG. 5 is a memory bit diagram of the remote-control transmitter according to Embodiment 2;

FIG. 6 is a circuitry diagram of a conventional remote-control transmitter; and

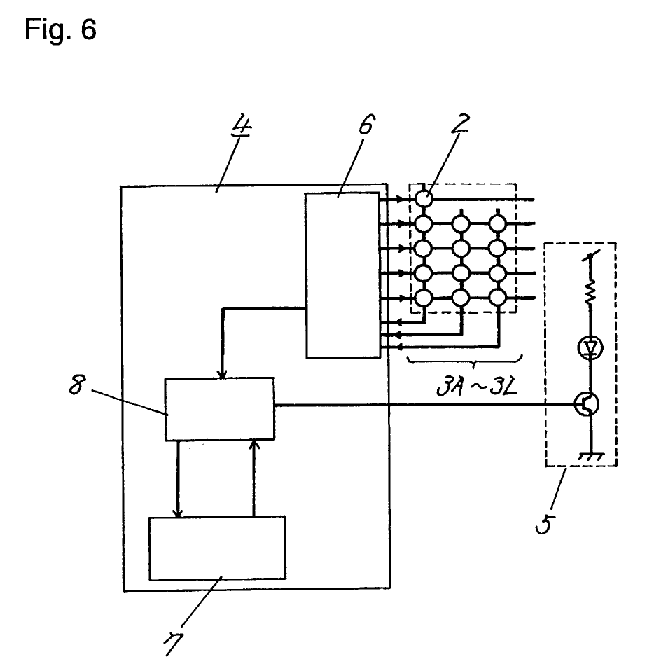

FIG. 7 is an external perspective view of the conventional remote-control transmitter.

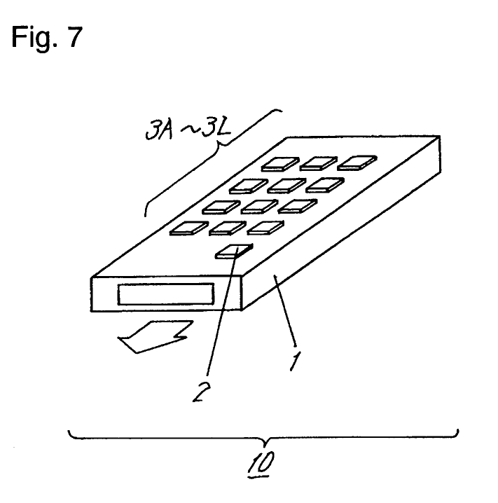

### BEST MODES FOR EMBODYING THE INVENTION

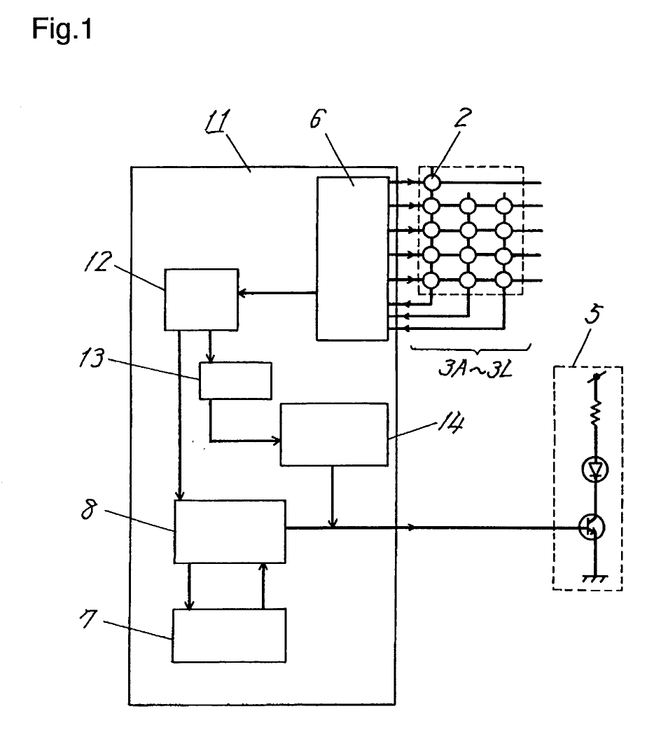

Preferred embodiments of the present invention will be described referring to FIGS. 1 through 5.

Like components are denoted by like numerals as those explained in Background Art of the specification and may be described in no more detail.

(Embodiment 1)

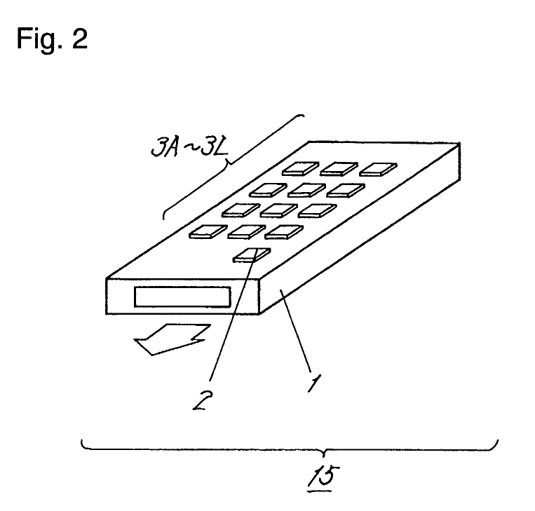

FIG. 1 is a circuitry diagram of a remote-control transmitter according to Embodiment 1 of the present invention, and FIG. 2 is an external perspective view of the transmitter. A power-on key 2 and an array of channel keys 3A through 3L project from the upper surface of a box-like insulating resin case 1 with vertically moving ability. Switch contacts corresponding to the keys are disposed beneath the keys and over a printed circuit board (not shown) installed in the case 1. The power-on key 2 and the channel keys 3A through 3L are connected to a microcomputer 11 coupled to a transmission circuit 5. The microcomputer 11 comprises: a key opening-closing detector 6 for detecting the opening and closing actions of each key switch contract; a transmission code memory 7 for storing the transmission code of each of the keys; and a control signal generator 8 operable to, according to the opening-closing signal of each key from the detector 6, read the transmission code of the key, to generate a remote-control signal from the key, and to drive the transmission circuit 5. The components are identical to those shown in the prior art. The transmitter of this embodiment also includes a process selector 12 provided between the key opening-closing detector 6 and the control signal generator 8.

The process selector 12 is also coupled to a key data memory 13 storing the data of the key in a test mode. The key data memory 13 is then coupled to a test signal generator 14 generating a test signal from the data of the key to drive the transmission circuit 5.

A method of testing the remote-control transmitter will now be described. The transmitter is turned on with pressing a specific key, e.g. the two channel keys 3A and 3B, and switch contacts corresponding to the keys are closed. When receiving two opening-closing signals unusually sent at a time from the key opening-closing detector 6, the process selector 12 judges that the action is not a common operation mode but a test mode. And the selector 12 transfers all the key opening-closing signals received after then to the key data memory 13 but not the control signal generator 8.

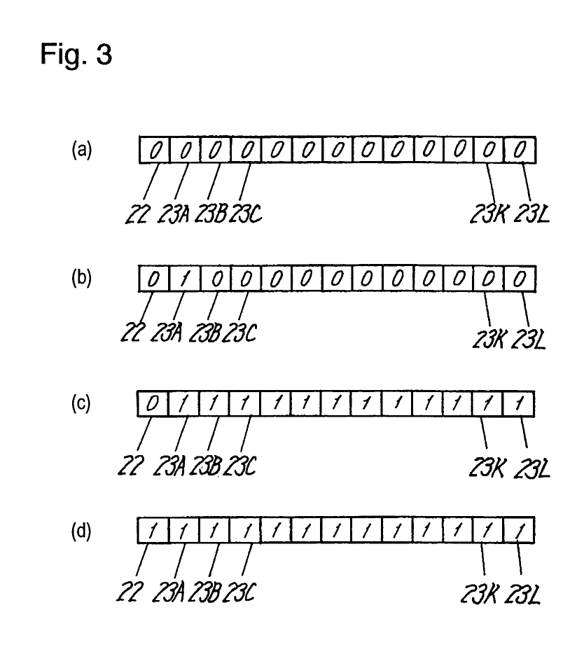

The key data memory 13 may include a memory bit 22 storing the opening-closing signal from the power-on key 2 and a series of bits 23A through 23L storing the opening-closing signals from the keys 3A through 3L, as shown in a memory bit diagram in FIG. 3. In general, the bits are initialized to zero as shown in FIG. 3(a).

After the microcomputer 11 is shifted to the test mode, if pressing the channel key 3A closes normally the switch contact beneath the key, the opening-closing signal of the key 3A is transmitted from the key opening-closing detector 6 via the process selector 12 to the key data memory 13. The memory bit 23A of the key data memory 13 is consequently set to “1” as shown in FIG. 3(b).

If the switch contact is malfunctioned, or if the printed circuit board of the switch contacts has a fault such as a disconnection, the detector 6 fails to release the opening-closing signal, and thus, the memory bit 23A in the key data memory 13 remains at “0”.

As the channel keys 3B through 3L are pressed down in a sequence, their opening-closing signals are transmitted via the process selector 12 to the key data memory 13. And the memory bits 23B through 23L in the key data memory 13 are consequently set to “1”.

Finally, when a specific key advantageously registered in the key data memory 13, e.g. power-on key 2, is pressed, the opening-closing signal of the key is transmitted from the process selector 12 to the key data memory 13. This has the memory bit 22 in the key data memory 13 set to “1” as shown in FIG. 3(d). The key data memory 13 then transfers the key opening-closing data of the key to the test signal generator 14.

The test signal generator 14 then generates a remote-control test signal from the key opening-closing data and delivers a group of the remote-control test signals at once to the transmission circuit 5. The transmission circuit 5 transmits the remote-control test signals as an infrared ray signal to the tester (not shown). The infrared ray signal is examined in the tester whether the switch contact of each key is correctly closed or not.

Assuming that the pressing of each key takes 0.1 second, the transmitting of a test signal from the remote-control transmitter 15 to the tester takes 0.2 second, and the receiving and identifying of the test signal takes 0.1 second, the duration of testing the remote-control transmitter with thirteen keys shown in FIG. 2 is:

0.1×13(keys)+0.2+0.1=1.6(seconds)

Alternatively, a remote-control transmitter with fourteen keys may be tested in 4.3 seconds.

Then, when specific keys, e.g. the power-on key 2 and the channel key 3A, are pressed at once, the process selector 12 in the microcomputer 11 shifts back from the test mode to the common operation mode. This allows any succeeding key opening-closing signal to be transferred to the control signal generator 8 but not the key data memory 13. The control signal generator 8 then generates the remote-control signal from each key in the same manner as of the prior art. As the transmission circuit 5 is driven, the remote-control signal is radiated as an infrared ray signal from the transmission circuit 5 to an electronic apparatus (not shown). The remote-control transmitter 15 can accordingly control the electronic apparatus from a distance.

According to Embodiment 1 of the present invention, the remote-control transmitter is reduced in its price, and the method of testing the transmitter is minimized in a time for testing.

In this embodiment, pressing the two channel keys 3A and 3B has the process selector 12 in the microcomputer 11 be shifted from the common operation mode to the test mode, pressing the power-on key 2 have the remote-control test signals transmitted to the tester as an infrared ray signal to the tester, and pressing the power-on key 2 and the channel key 3A has the test mode be shifted back to the common operation mode. The keys are not limited to those. The technology of the present invention may be implemented through operation of any combination or one of the keys.

(Embodiment 2)

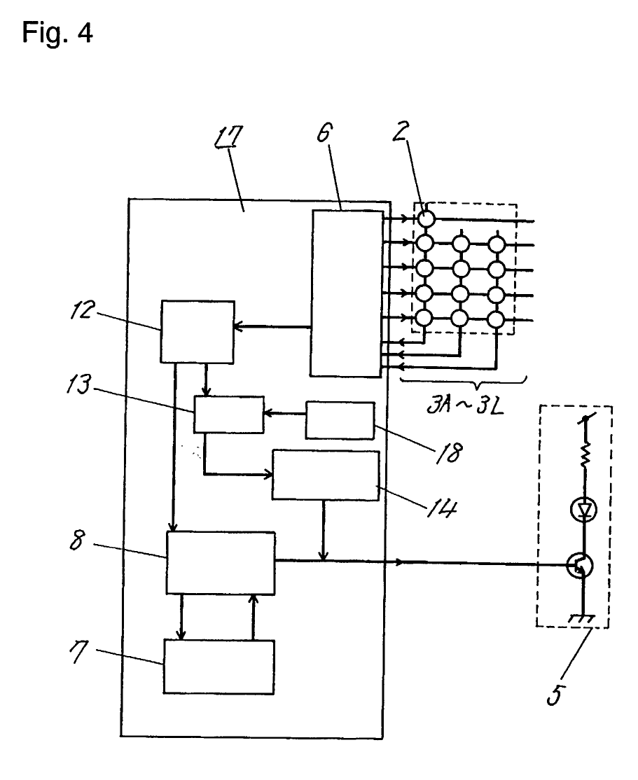

FIG. 4 is a circuitry diagram of a remote-control transmitter according to Embodiment 2 of the present invention.

Various types of remote-control transmitters are used with various functions and transmission codes, depending on the types or the manufacturers of electronic apparatus to be controlled such as television receivers or video recorder/players. More specifically, a microcomputer and the number of keys are different between the remote-control transmitters. Any remote-control transmitter with a desired number of keys and a specific microcomputer can be inspected thanks to add an identification signal of the microcomputer 17 to a remote-control test signal, as shown in FIG. 4.

The microcomputer 17 includes a microcomputer code memory 18 coupled to the key data memory 13. The memory 18 stores microcomputer codes as the identification data. In action, the opening-closing signal of a pressed key is transmitted from the key opening-closing detector 6 via the process selector 12 to the key data memory 13. This permits the key data memory 13 to read out a microcomputer code of the microcomputer 17 from the microcomputer code memory 18.

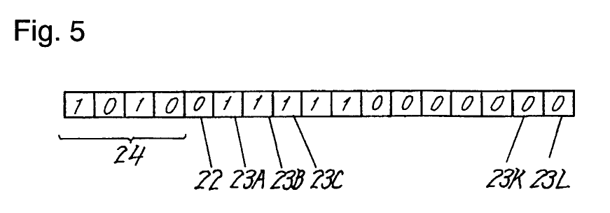

While the key opening-closing data are stored in the memory bits 23A through 23L in the key data memory 13, the identification data of the microcomputer 17 is stored as a code, e.g. “1010”, in the memory bit 24 as shown in a memory bit diagram of FIG. 5. The test signal generator 14 generates a remote-control test signal from those data and transfers a group of the test signals to the transmission circuit 5.

The transmission circuit 5 transmits the remote-control test signals as an infrared ray signal to the tester. Upon receiving the infrared ray signal, the tester examines whether the switch contact of each key is correctly closed or not and which model of the microcomputer is employed in the remote-control transmitter.

Accordingly, the remote-control transmitters with a various models of the microcomputers and a desired number of the keys can be tested. Even if employing an unsuitable model of the microcomputer, The transmitter can detect that because the identification data of the microcomputer 17 does not match to the opening-closing data of the keys.

The remote-control transmitter of an infrared ray type for transmitting the remote-control test signal as an infrared ray signal from the transmission circuit 5 in the embodiments. The technology of present invention is successfully applicable to a remote-control transmitter of a radio wave type for transmitting the remote-control test signal a radio signal.

Also, the technology of the present invention is not limited to the remote-control transmitter controlling a single electronic apparatus such as a television receiver or a video recorder/player. The technology may also be implemented in any other appropriate form such as a unified type remote-control transmitter for remote-controlling two or more electronic apparatuses. And it is also applicable to various types of remote-controlled apparatuses, e.g. an air-conditioning apparatus such as a cooler or heater system.

### Industrial Applicability

The present invention provides a remote-control transmitter for use with an electronic apparatus such as a television receiver or a video recorder/player and a method of testing the transmitter minimized in the overall duration for testing and the cost of the production.

1. A remote-control transmitter comprising:
a plurality of keys closing switch contacts corresponding thereto when pressed down;
a microcomputer coupled to said keys for generating a remote-control signal in response to pressing each of said keys; and
a transmission circuit coupled to said microcomputer for transmitting a remote-control signal, wherein the microcomputer is operable to:
be shifted to a test mode when a specific key of said keys is pressed;
store an opening-closing data of a key of the keys, saied key closed after the test mode is initiated; and
transfer the opening-closing data as a remote-control test signal to said transmission circuit at once.

2. The remote-control transmitter according to claim 1, wherein said transmission circuit transmits the remote-control signal and the remote-control test signal as one of an infrared ray signal and a radio signal.

3. The remote-control transmitter according to claim 1, wherein the remote-control test signal additionally carries an identification signal of said microcomputer.

4. A remote-control transmitter according to claim 3, wherein said transmission circuit transmits the remote-control signal and the remote-control test signal as one of an infrared ray signal and a radio signal.

5. A method of testing a remote-control transmitter which comprises: a plurality of keys closing switch contacts corresponding thereto when pressed down; a microcomputer coupled to the keys for generating a remote-control signal in response to pressing the keys; and a transmission circuit coupled to the microcomputer for transmitting the remote-control signal, comprising:
shifting the microcomputer to a test mode when a specific key of the keys is pressed down;
storing an opening-closing data of a key of the keys, said key closed after the test mode is initiated;
transferring the opening-closing data as a remote-control test signal to the transmission circuit at once; and
examining the remote-control test signal.

6. The method of testing the remote-control transmitter according to claim 5, wherein the transmission circuit transmits the remote-control signal and the remote-control test signal as one of an infrared ray signal and a radio signal.

7. The method of testing the remote-control transmitter according to claim 5, wherein the remote-control test signal additionally carries an identification signal of the microcomputer.

8. A method of testing a remote-control transmitter according to claim 7, wherein the transmission circuit transmits the remote-control signal and the remote-control test signal as one of an infrared ray signal and a radio signal.
